(19) United States
(12) Patent Application Publication
(10) Pub. No.: US 2016/0239185 A1
(43) Pub. Date: Aug. 18, 2016

(54) METHOD, SYSTEM AND APPARATUS FOR ZOOMING IN ON A HIGH LEVEL NETWORK CONDITION OR EVENT

(71) Applicant: Brocade Communications Systems, Inc., San Jose, CA (US)

(72) Inventors: Vamsi Krishna Balimidi, Fremont, CA (US); Sathish Kumar Gnansekaran, Sunnyvale, CA (US)

(21) Appl. No.: 14/623,137

(22) Filed: Feb. 16, 2015

(51) Int. Cl. G06F 3/0484; G06F 3/14; G06F 3/0482

(52) U.S. Cl. CPC G06F 3/04845; G06F 3/04847; G06F 3/0482; G06F 3/14

(57) ABSTRACT

A high level network topology is generated and displayed, illustrating the interconnection of various network devices. At least one network device graphically represented in the network topology may be “zoomed-in” on, which shows additional, more detailed performance parameters of the at least one network device. Using these additional performance parameters, an administrator may be able to more effectively monitor network devices in order to determine the source or effect of a network event.

### BACKGROUND OF THE INVENTION

1. Field of the Invention

The invention relates generally to methods and systems for monitoring data networks, and more particularly, to a computer-based method, system, and apparatus for alternating from a high level view of a potential event on a network topology to a detailed (i.e., “zoomed-in”) view of the potential event, thereby potentially allowing an administrator to more efficiently determine the source of the network event.

2. Description of the Related Art

Communications networks, including without limitation wide area networks (“WANs”), local area networks (“LANs”), and storage area networks (“SANs”), may be implemented as a set of interconnected switches that connect a variety of network-connected nodes to communicate data and/or control packets among the nodes and switches. For a growing number of companies, planning and managing data storage is critical to their day-to-day business and any downtime or even delays can result in lost revenues and decreased productivity. Increasingly, these companies are utilizing data storage networks, such as SANS, to control data storage costs as these networks allow sharing of network components and infrastructure while providing high availability of data. While managing a small network may be relatively straightforward, most networks are complex and include many components and data pathways from multiple vendors, and the complexity and the size of the data storage networks continue to increase when a company's need for data storage grows and additional components are added to the network.

Despite the significant improvements in data storage provided by data storage networks, performance can become degraded in a number of ways. For example, performance may suffer when a bottleneck situation occurs. Specifically, the transfer of packets throughout the network results in some links carrying a greater load of packets than other links. Often, the packet capacity of one or more links is oversaturated (or “congested”) by traffic flow, and therefore, the ports connected to such links become bottlenecks in the network. In addition, bottlenecked ports can also result from “slow drain” conditions, even when the associated links are not oversaturated. Generally, a slow drain condition can result from various conditions, although other slow drain conditions may be defined by: (1) a slow node outside the network is not returning enough credits to the network to prevent the connected egress port from becoming a bottleneck; (2) upstream propagation of back pressure within the network; and (3) a node has been allocated too few credits to fully saturate a link. As such, slow drain conditions can also result in bottlenecked ports. In a large SAN, the flow of data is concentrated in Inter-Switch Links (ISLs), and these connections are often the first connections that saturate with data. Also, performance may be degraded when a data path includes devices, such as switches, connecting cable or fiber, and the like, that are mismatched in terms of throughput capabilities, as performance is reduced to that of the lowest performing device.

A common measurement of performance of a network is utilization, which is typically determined by comparing the throughput capacity of a device or data path with the actual or measured throughput at a particular time, e.g., 1.5 gigabits per second measured throughput in a 2 gigabit per second fiber is 75 percent utilization. Hence, an ongoing and challenging task facing network administrators is managing a network so as to avoid underutilization (i.e., wasted throughput capacity) and also to avoid overutilization (i.e., saturation of the capacity of a data path or network device). These performance conditions can occur simultaneously in different portions of a single network such as when one data path is saturated while other paths have little or no traffic. Underutilization can be corrected by altering data paths to direct more data traffic over the low traffic paths, and overutilization can be controlled by redirecting data flow, changing usage patterns such as by altering the timing of data archiving and other high traffic usages, and/or by adding additional capacity to the network. To properly manage and tune network performance including utilization, monitoring tools are needed for providing performance information for an entire network to a network administrator in a timely and useful manner.

The number and variety of devices that can be connected in a data storage network such as a SAN are often so large that it is very difficult for a network administrator to monitor and manage the network. Network administrators find themselves confronted with networks having dozens of servers connected to hundreds or even thousands of storage devices over multiple connections, e.g., via many fibers and through numerous switches. Understanding the physical layout or topology of the network is difficult enough, but network administrators are also responsible for managing for optimal performance and availability and proactively detecting and reacting to potential failures. Such network administration requires performance monitoring, and the results of the monitoring need to be provided in a way that allows the administrator to easily and quickly identify problems, such as underutilization and overutilization of portions of a network.

Network management software provides network administrators a way of tracking, among other things, data utilization, the number of errors (e.g., cyclic redundancy check or “CRC” errors) occurring on network devices, and overall data flow information. For smaller networks with a fewer number of ports, monitoring these characteristics of a network in detail may be simple for an administrator. In stark contrast, for large networks there are often so many ports spread amongst so many different devices that it is necessary to display the network topology in the network management software in a high level view. In this way, an administrator may monitor all traffic flow occurring on the network. However, because so many different nodes are being monitored at once, it is not feasible to measure performance parameters of each device on the network in detail. For example, it may only be feasible to measure the general data rate and directional flow of the devices on the network, which renders trouble shooting very difficult and time consuming.

Existing network monitoring tools fail to meet all the needs of network administrators. Monitoring tools include tools for discovering the components and topology of a data storage network. The discovered network topology is then displayed to an administrator on a graphical user interface (GUI). While the topology display or network map provides useful component and interconnection information, there is typically limited information provided regarding the performance of the network. If any information is provided, it is usually displayed in a static manner that may or may not be based on real time data. For example, some monitoring tools display an icon as enlarged for components with higher utilization, which may not convey adequate information to allow the administrator to determine the precise cause of the high utilization. More typical monitoring tools only provide performance information in reports and charts that show utilization or other performance information for devices in the network at various times. These tools are not particularly useful for determining the present or real time usage of a network as an administrator is forced to sift through many lines and pages of a report or through numerous charts to identify problems and bottlenecks and often have to look at multiple reports or charts at the same time to find degradation of network performance. Though some monitoring tools display basic flow information in a graphic representation, such as the direction of data flow on the network and data utilization, there may still be insufficient information for an administrator to determine the source and severity of a network event (e.g., bottlenecking).

### SUMMARY OF THE INVENTION

Implementations of the presently disclosed invention relate to focusing in detail on a portion of a network topology that is potentially generating a network event, such as a bottleneck or an abnormal number of CRC errors. When a significant number of errors (e.g., CRC errors) or other events (e.g., high utilization) are detected in a region of a large network, the embodiments begin measuring detected performance parameters of the relevant or related devices. This allows the administrator to focus on the troublesome portion of the network in detail by tracking many more detailed performance parameters relating to the portion of the network being affected. In selected embodiments, the display automatically changes to provide the greater detail provided by the more detailed measurements. Further, the presently disclosed technology is capable of alternating between a high level network topology view to a more detailed network topology view (e.g., a port-level view), including performance parameters of a particular device, that is sufficient to allow an administrator to determine the source of a network event.

This technique can be used on any telecommunication network.

### BRIEF DESCRIPTION OF THE FIGURES

The accompanying drawings, which are incorporated in and constitute a part of this specification, illustrate an implementation of apparatuses and methods consistent with the present invention and, together with the detailed description, serve to explain advantages and principles consistent with the invention.

FIG. 1 is a simplified block diagram of a data traffic monitoring system according to the present invention including a performance monitoring mechanism for generating an animated display showing performance parameters relative to a high level network map or topology.

FIG. 2 is a flow chart for one exemplary method of generating performance monitoring displays, such as with the performance monitoring mechanism of FIG. 1.

FIG. 3 illustrates a network administrator user interface with a network map or topology generated, such as with information obtained using the discovery mechanism of FIG. 1.

FIG. 4 illustrates the user interface of FIG. 3 with the network map or topology being modified to provide a performance monitoring display that illustrates one or more performance parameters for the network.

FIG. 5 illustrates a detailed or “zoomed-in” display of a network map or topology based on the network map or topology from FIG. 4. The illustrated topology includes granular information relating to only one particular device of the network.

FIG. 6 illustrates a second detailed or “zoomed-in” display of a network map or topology based on the network map or topology from FIG. 4. The illustrated topology includes granular information relating to two particular devices of the network topology.

FIG. 7 is a flow chart for one exemplary method of alternating from a high level view of the network topology illustrated in FIG. 4 to the detailed or “zoom-in” display of FIGS. 5-6.

### DETAILED DESCRIPTION OF THE PREFERRED EMBODIMENTS

The present invention is directed to an improved method, apparatus and computer-based system, for displaying performance information for a data network. The following description stresses the use of the invention for monitoring data storage networks, such as storage area networks (SANs) and network attached storage (NAS) systems, but is useful for monitoring operating performance of any data communication network in which data is transmitted digitally among networked components. One feature of the disclosed apparatus is that detailed performance and other detailed information, such as utilization of a data connection, is collected, if needed, and displayed in a detailed (i.e., “zoomed-in”) view for a particular network device or devices. The detailed data collection and view may be triggered, for example, by a rule or service policy configured to alert a network administrator when a certain threshold for events (e.g., CRC or invalid transmission word errors (ITW)) has been surpassed on at least one network device(s). This may cause an overall network topology view showing general performance parameters, such as data rate and directional flow, to zoom-in to a detailed view, which shows more detailed performance parameters or information relating to the network device ports of the at least one network device(s). Thus, an administrator may view more detailed performance parameters of the particular ports of the at least one network device in real-time, thereby allowing the administrator to more effectively determine the source of a network event, such as bottlenecking.

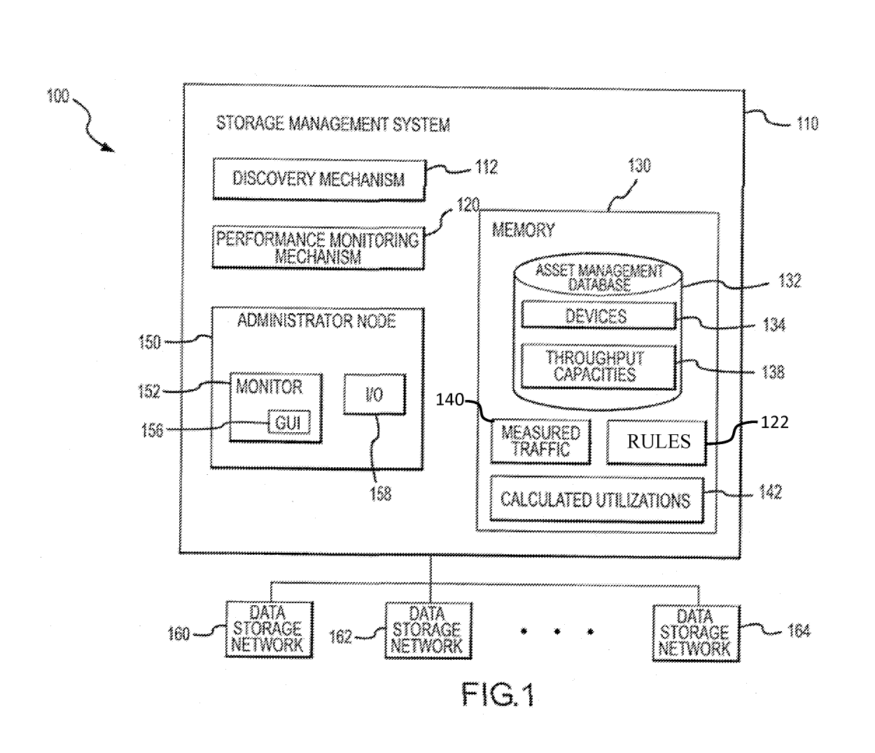

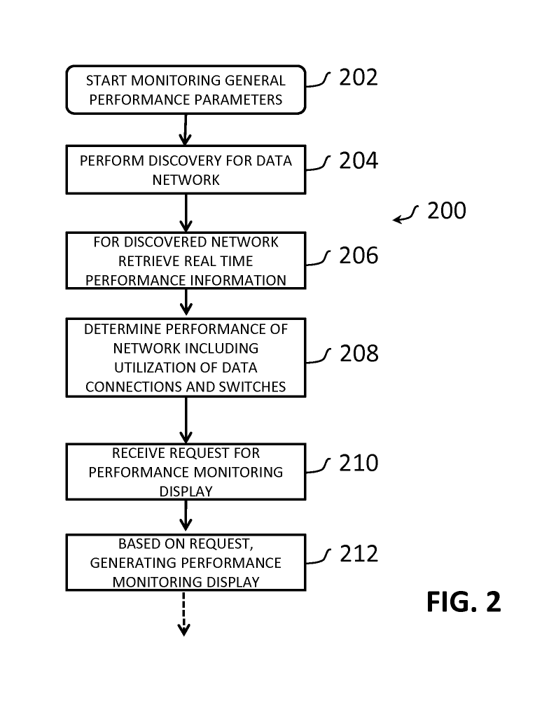

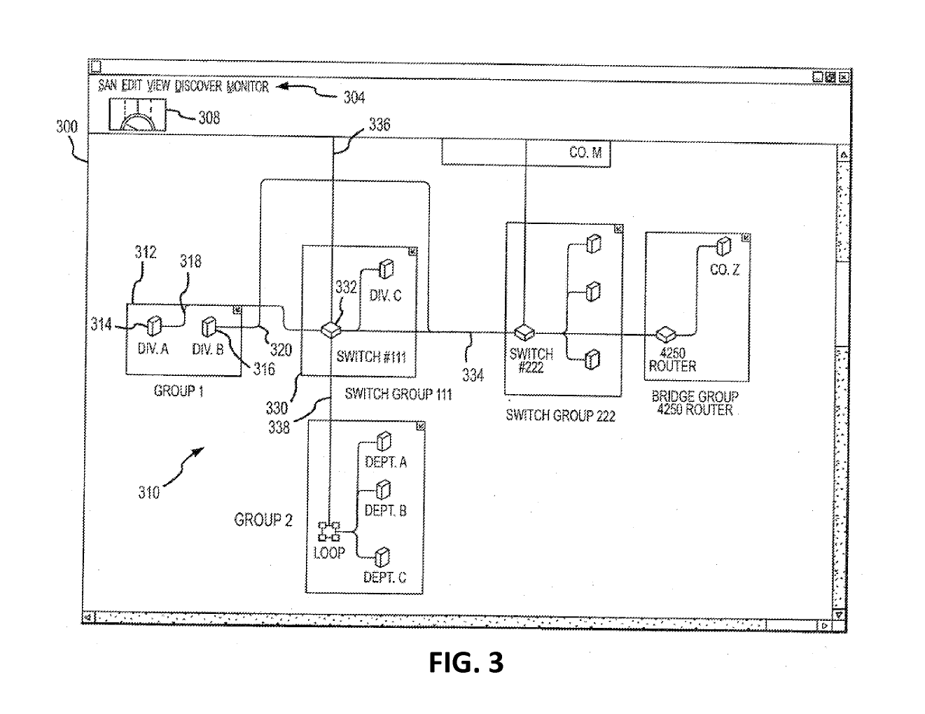

With this in mind, the following description begins with a description of an exemplary data monitoring system with reference to FIG. 1 that implements components, including a performance monitoring mechanism, that are useful for determining performance information and then generating a display with a network topology or map along with performance information. The description continues with a discussion of general operations of the monitoring system and performance monitoring mechanism with reference to the flow chart of FIG. 2. The operations are described in further detail with FIGS. 3-7 that illustrate screens of user interfaces created by the system and performance monitoring system of the invention and which include various displays that may be generated according to the invention to selectively show network performance information.

FIG. 1 illustrates one embodiment of a data traffic monitoring system 100 according to the invention. In the following discussion, computer and network devices, such as the software and hardware devices within the system 100, are described in relation to their function rather than as being limited to particular electronic devices and computer architectures and programming languages. To practice the invention, the computer and network devices may be any devices useful for providing the described functions, including well-known data processing and communication devices and systems, such as application, database, and web servers, mainframes, personal computers and computing devices (and, in some cases, even mobile computing and electronic devices) with processing, memory, and input/output components, and server devices configured to maintain and then transmit digital data over a communications network. The data storage networks 160, 162, 164 may be any network in which storage is made available to networked computing devices such as client systems and servers and typically may be a SAN, a NAS system, and the like and includes connection infrastructure that is usually standards-based, such as based on the Fibre Channel standard, and includes optical fiber (such as 8 to 16 gigabit/second capacity fiber) for transmit and receive channels, switches, routers, hubs, bridges, and the like. The administrator node(s) 150 and storage management system 110 running the discover mechanism 112 and performance monitoring mechanism 120 may be any computer device useful for running software applications including personal computing devices such as desktops, laptops, notebooks, and even handheld devices that communicate with a wired and/or wireless communication network. Data, including discovered network information, performance information, and generated network performance displays and transmissions to and from the elements of the system 100 and among other components of the system 100 typically is communicated in digital format following standard communication and transfer protocols, such as TCP/IP, HTTP, HTTPS, FTP, and the like, or IP or non-IP wireless communication protocols such as TCP/IP, TL/PDC-P, and the like.

Referring again to FIG. 1, the system 100 includes a network management system 110, which may include one or more processors (not shown) for running the discovery mechanism 112 and the performance monitoring mechanism 120 and for controlling operation of the memory 130. The storage management system 110 is shown as one system but may readily be divided into multiple computer devices. For example, the discovery mechanism 112, performance monitoring mechanism 120, memory 130 and administrator node 150 may each be provided on separate computer devices or systems that are linked (such as with the Internet, a LAN, a WAN, or direct communication links). The storage management system 110 is linked to data storage networks 160, 162, 164 (with only three networks being shown for simplicity but the invention is useful for monitoring any number of networks such as 1 to 1000 or more). As noted above, the storage networks 160, 162, 164 may take many forms and are often SANs that include numerous servers or other computing devices or systems that run applications which require data which is stored in a plurality of storage devices (such as tape drives, disk drives, and the like) all of which are linked by an often complicated network of communication cables (such as cables with a transmit and a receive channel provided by optical fiber) and digital data communication devices (such as multi-port switches, hubs, routers, and bridges well-known in the arts).

The memory 130 is provided to store discovered data, e.g., display definitions, movement rates or speeds, and color code sets for various performance information, and discovered or retrieved operating information. For example, as shown, the memory 130 stores an asset management database 132 that includes a listing of discovered devices in one or more of the data storage networks 160, 162, 164 and throughput capacities or ratings for at least some of the devices 134 (such as for the connections and switches and other connection infrastructure). The memory 130 further is used to store measured performance information, such as measured traffic 140 and to store at least temporarily calculated utilizations 142 or other performance parameters. The memory 130 also stores rules or service policies 122, which are utilized to trigger certain actions or processes on the storage management system 110. The rules or service policies 122 will be discussed in greater detail below.

The administrator node 150 is provided to allow a network administrator or other user to view performance monitoring displays created by the performance monitoring mechanism 120 (as shown in FIGS. 3-6). In this regard, the administrator node 150 includes a monitor 152 with a graphical user interface 156 through which a user of the node 150 can view and interact with created and generated displays. Further, an input and output device 158, such as a mouse, touch screen, keyboard, voice activation software, and the like, is provided for allowing a user of the node 150 to input information, such as requesting a performance monitoring display or manipulation of such a display as discussed with reference to FIGS. 2-7.

The discovery mechanism 112 functions to obtain the topology information or physical layout of the monitored data storage networks 160, 162, 164 and to store such information in the asset management database. The discovered information in the database 132 includes a listing of the devices 134, such as connections, links, switches, routers, and the like, in the networks 160, 162, 164 as well as rated capacities or throughput capacities 138 for the devices 134 (as appropriate depending on the particular device, i.e., for switches the capacities would be provided for its ports and/or links connected to the switch). The discovery mechanism 112 may take any of a number of forms that are available and known in the information technology industry as long as it is capable of discovering the network topology of the fabric or network 160, 162, 164. Typically, the discovery mechanism 112 is useful for obtaining a view of the entire fabric or network 160, 162, 164 from host bus adapters (HBAs) to storage arrays, including IP gateways and connection infrastructure.

Additionally, the discovery mechanism 112 functions on a more ongoing basis to capture periodically (such as every 2 minutes or less) performance information from monitored data storage networks 160, 162, 164. In embodiments which map or display data traffic and/or utilization, the mechanism 112 acts to retrieve measured traffic 140 from the networks 160, 162, 164 (or determines such traffic by obtaining switch counter information and calculating traffic by comparing a recent counter value with a prior counter value, in which case the polling or retrieval period is preferably less than the time in which a counter may roll over more than once to avoid miscalculations of traffic). In one embodiment of the invention, the performance information (including the traffic 140) is captured from network switches using Simple Network Management Protocol (SNMP) but, of course, other protocols and techniques may be used to collect his information. In practice, the information collected by each switch in a network 160, 162, 164 may be pushed at every discovery cycle (i.e., the data is sent without being requested by the discovery mechanism 112). A performance model including measured traffic 140 is sometimes stored in memory 130 to keep the pushed data for each switch.

The performance monitoring mechanism 120 functions to determine performance parameters that are later displayed along with network topology in a network monitoring display in the GUI 156 on monitor 150 (as shown in FIGS. 3-7 and discussed more fully with reference to FIG. 2). In preferred embodiments, one performance parameter calculated and displayed is calculated utilizations or utilization rates 142 which are determined using a most recently calculated or measured traffic value 140 relative to a rated capacity 138. For example, the measured (or determined from two counter values of a switch port) traffic 140 may be 8 gigabit of data/second and the throughput capacity for the device, e.g., a connection or communication channel, may be 16 gigabits of data/second. In this case, the calculated utilization 142 would be 50 percent.

The performance monitoring mechanism 120 acts to calculate such information for each device in a network 160, 162, 164, including individual ports, and to display such performance information for each device (e.g., link) in a displayed network along with the topology. The method utilized by the performance monitoring mechanism 120 in displaying the topology may vary to practice the invention as long as the components of a network are represented along with interconnecting data links (which as will be explained are later replaced with performance displaying links). Further, in some embodiments, the map or topology is generated by a separate device or module in the system 110 and passed to the performance monitoring mechanism 120 for modification to show the performance information. Techniques for identifying and displaying network devices and group nodes as well as related port information are explained in U.S. patent application Ser. No. 09/539,350 entitled “Methods for Displaying Nodes of a Network Using Multilayer Representation,” U.S. patent application Ser. No. 09/832,726 entitled “Method for Simplifying Display of Complex Network Connections Through Partial Overlap of Connections in Displayed Segments,” and U.S. patent application Ser. No. 09/846,750 entitled “Method for Displaying Switched Port Information in a Network Topology Display,” and U.S. patent application Ser. No. 11/748,646 titled “Method and System for Generating a Network Monitoring Display with Animated Utilization Information,” each of which are hereby incorporated herein by reference.

In addition to the capabilities discussed above, the performance monitoring mechanism 120 may be configured to cause monitored devices to collect certain, more detailed, performance parameters, which results are then sampled by the discovery mechanism 112 and used by the performance monitoring mechanism 120. As previously discussed, because there are so many network nodes on large networks, it may not be feasible for all the devices to develop the detailed performance parameters and/or for the performance monitoring mechanism 120 to monitor all of the detailed performance parameters of a network at once. Even if the system were capable of tracking the detailed performance parameters of every network device on the network, it may create too much clutter at the high level view to display such information for the entire network. Generally, the performance monitoring mechanism 120 may be configured to sample certain performance parameters at a rate that is not unduly burdensome on the storage management system 110. For example, a particular metric of the ports on all network devices (e.g., switches) may be polled at a rate of once every 6 seconds, as opposed to constant real-time sampling. The metric may be, for example, CRC or ITW errors on each port or port utilization. This may allow the network management software 110 to keep track of key performance parameters on the network that may be indicative of a network event. The rules or service policies 122 may be configured by the administrator to create an alert or notification when a certain threshold has been reached. For instance, a network administrator may set the rules or service policies 122 to generate an alert or notification once a port reaches 90% utilization, or when over fifty CRC or ITW errors have occurred. Once this threshold has been reached, the network management system 110 may notify the administrator and/or trigger a separate event. Examples of separate events in the preferred embodiment include commencing a more detailed performance analysis on relevant devices, increasing the sampling rate on relevant devices and automatically changing a display to focus on the relevant devices.

The operation of the storage management system 110 and, particularly, the performance monitoring mechanism 120 are described in further detail in the monitoring process 200 shown in FIG. 2. It should be noted initially that the method 200 is a simplified flowchart to represent useful processes but does not limit the sequence that functions take place.

As shown, the monitoring process 200 starts at 202 typically with the loading of discovery mechanism 112 and performance monitoring mechanism 120 on system 110 and establishing communication links with the administrator node 150 and data storage networks 160, 162, 164 (and if necessary, with memory 130). At this step, the performance monitoring mechanism 120 continuously monitors, in real-time, more general, less detailed performance parameters, such as the data rate and direction flow of data through each port on the network. The performance monitoring mechanism 120 also samples certain more detailed performance metrics that may be indicative of a network event. Such metrics include, but are not limited to, CRC and ITW errors, data utilization, data flow, timeout errors, hardware temperature, and hardware buffer size. While numerous examples of metrics have been discussed, a person of ordinary skill in the art would recognize that any metric capable of indicating a network event may be occurring may be monitored. Which parameters are sampled and monitored are entirely at the discretion of the network administrator, and are typically configured prior to the performance monitoring occurring.

At 204, discovery is performed with the mechanism 112 for one or more of the data storage networks 160, 162, 164 to determine the topology of the network and the device lists 134 and capacity ratings 138 are stored in memory 130. In some embodiments, such discovery information is provided by a module or device outside the system 110 and is simply processed and stored by the performance monitoring mechanism 120.

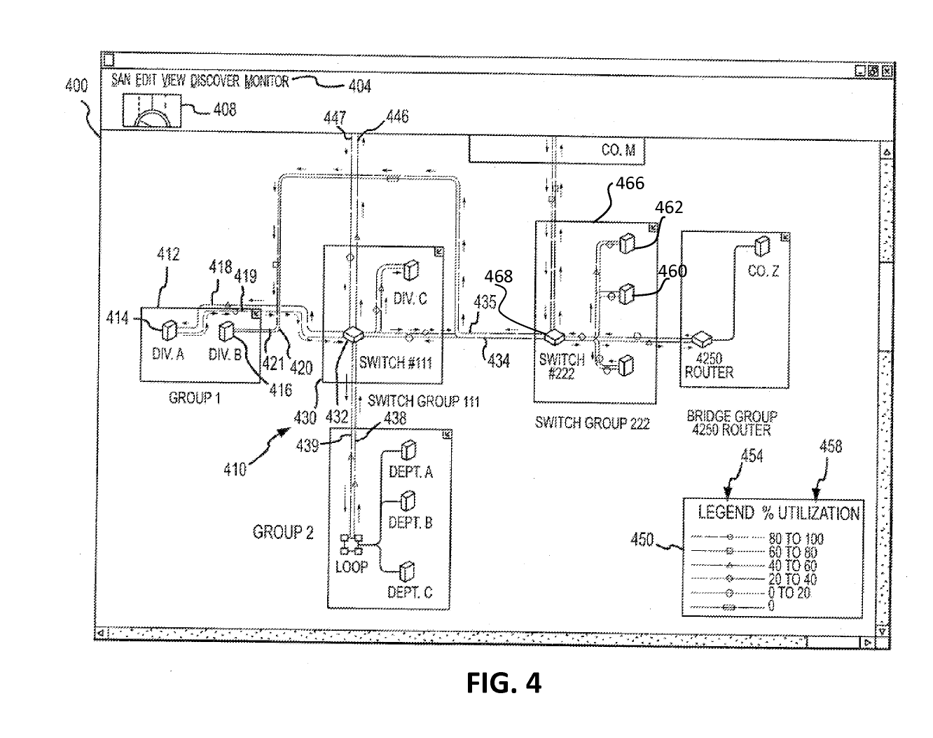

Also, at 204, the performance monitoring mechanism 120 (or other display generating device not shown) may operate to display the discovered topology in the GUI 156 on the monitor 150. For example, screen 300 of FIG. 3 illustrates one useful embodiment of GUI 156 that may be generated by the mechanism 120 and includes pull down menus 304 and a performance display button 308, which when selected by a user results in performance monitoring mechanism 120 acting to generate a performance monitoring display 400 shown in FIG. 4. The network display 300 is generated to visually show the topology or map 310 of one of the data storage networks 160, 162, 164 (i.e., the user may select via the GUI 156 which network to display or monitor). The network topology 310 shows groups of networked components that are linked by communication connections (such as pairs of optical fibers). The display 300 shows this physical topology 310 with icons representing computer systems, servers, switches, loops, routers, and the like and single lines for data paths or connections. The discovered topology 310 in the display 300 includes, for example, a first group 312 including a system 314 from a first company division and a system 316 from a second company division that are linked via connections 318, 320 to switch 332. A switch group 330 is illustrated that includes switch 332 and another division server. The switch 332 is shown to be further linked via links 334, 336, and 338 to other groups and devices. As shown, performance information is not shown in the display 300 but a physical topology 310 is shown and connections are shown with single lines. Note, to practice the invention the physical topology does not have to be displayed but typically is at least generated prior to generating of the performance monitoring display (such as the one shown in FIG. 4) to facilitate creating such a display.

Referring again to FIG. 2, the process 200 continues at 206 with real time information being collected for the discovered network 160, 162, 164 such as by the discovery mechanism 120 either through polling of devices such as the switches or more preferably by receiving pushed data that is automatically collected once every discovery cycle (such as switch counter information for each port). The data is stored in memory 130 such as measured traffic or bandwidth 140. In this manner, real time (or only very slightly delayed) performance information is retrieved and utilized in the process 200. In some embodiments, the discovery mechanism 112 further acts to rediscover physical information or topology information and network operating parameters (such as maximum bandwidth of existing fibers) periodically, such as every discovery cycle or once every so many cycles, so as to allow for changes and updates to the physical or operational parameters of one of the monitored networks 160, 162, 164.

At 208, the performance monitoring mechanism 120 acts to determine the performance of the monitored network 160, 162, 164. Typically, this involves determining one or more parameters for one or more devices. For example, utilization of connections can be determined as discussed above by dividing the measured traffic by the capacity stored in memory at 138. Utilization can also be determined for switches and other devices in the monitored network. The calculated utilizations are then stored in memory 142 for later use in creating an animated display and for creating a display of the performance parameters of particular network devices, including their ports. The performance parameters may include other measurements such as actual transfer rate in bytes/second or any other useful performance measurement. Further, the utilization rate does not have to be determined in percentages but can instead be provided in a log scale or other useful form. The utilization rate may include measurements for particular switches and devices (e.g., servers, host computers, etc.), as well as individual ports on those switches and devices.

At 210, the process 200 continues with receiving a request for a performance monitoring display from the user interface 156 of the administrator node 150. Such a request may take a number of forms such as the selection of an item on a pull down menu 304 (such as from the “View” or “Monitor” menus) or from the selection with a mouse of the animated display button 308. Typically, such a request is received at the network management system 110 by the performance monitoring mechanism 120.

At 212, the performance monitoring mechanism 120 functions to generate a performance monitoring display based using the topology information from the discovery mechanism 112 and the performance information from step 208. A screen 400 of GUI 156 after performance of step 212 is shown in FIG. 4. FIG. 4 illustrates a high level view of the network topology in the GUI of the system 100. In the illustrated embodiment, the display 310 of FIG. 3 is replaced or updated to show performance information on or in addition to the topology or map of the network 160, 162, 164 to allow a viewer to readily link performance levels with particular components or portions of the represented network 160, 162, 164. The GUI again includes a pull down menu 404 and a performance monitoring button 408 (which if again selected would revert the display 410 to display 310).

Additionally, the display 410 is different from the pure topology display 310 in that the single line links or connections have been replaced with double-lined connections or performance-indicating links that include a line for each communication channel or fiber, e.g., 2 lines for a typical connection representing a receive channel and a transmit channel.

Referring to FIG. 4, a first group 418 as in FIG. 3 includes a computer system 414 of a first division and a computer system 416 of a second division. Computer system 414 is in communication with switch 432 of switch group 430. However, instead of using a single line to show the connection the real time performance of each channel of the link are shown with the pair of lines 418 and 419. In the illustrated embodiment 410, the performance data being illustrated in conjunction with the network topology 410 of display 400 is utilization, with the utilization of channel or fiber 418 being 40 to 60 percent and the utilization of channel or fiber 419 being 80 to 100 percent.

There are a number of techniques utilized by the performance monitoring mechanism 120 to show such utilization values in the lines 418, 419. In one embodiment, the utilization variance is represented by using a solid line for zero utilization and a very highly dashed (or small dash length or line segment length) line for upper ranges of utilization, such as 80 to 100 percent. Hence, in this example, the higher number of dashes or shorter dash or line segment length indicates a higher utilization. Gaps are provided in the lines to create the dashes. In one embodiment, the gaps are set at a particular length to provide an equal size throughout the display. Generally, the gaps are transparent or clear such that the background colors of the display show through the gaps to create the dashed line effect, but differing colored gaps can be used to practice the invention.

In one embodiment, a legend 450 is provided that illustrates to a user with a legend column 454 and utilization percentage definition column 458 what a particular line represents. As shown in FIG. 4, the utilization results have been divided into 6 categories (although a smaller or larger number can be used without deviating significantly from the invention with 6 being selected for ease of representation of values useful for monitoring utilization). For example, the inactive links are drawn with a continuous line (no dash and no movement being provided as is explained below) with links that are mostly unused having long dashes (such as 100 pixel or longer segments) and links with the most activity having short dashes (such as 20 pixel or shorter line segments). Note, the display 410 is effective at showing that the flow or utilization in each of the channels 418, 419 can and often does vary, which would be difficult if not impossible to show when only a single connector is shown between two network components. This can be thought of as representing bi-directional performance of a link.

According to another example as shown, motion or movement is added to clearly represent the flow of data, the direction of data flow, and also the utilization rate that presently exists in a connection. In the display 410, motion in the dashed lines is indicated by the arrows, which would not be provided in the display 410. The arrows are also provided to indicate direction of the motion of the dashed lines (or line segments in the lines). In most embodiments, the motion is further provided at varying speeds that correspond to the utilization rate (or other performance information being displayed). For example, a speed or rate for “moving” the dashes or line segments increases from a minimum slow rate to a maximum high rate as the utilization rate being represented by the dashed line increases from the utilization range of 0 to 20 percent to the highest utilization range of 80 to 100 percent. While it may not be clear from FIG. 4, such a higher speed of dash movement is shown in the display 410 by the use of more motion arrows on line 419, which is representing utilization of 80 to 100 percent or near saturation, than on line 418, which is representing lower utilization of 40 to 60 percent. In other words, in practice, line 418 would be displayed at a slower speed in a GUI 156 than the line 419. This speed or rate of motion is another technique provided by the invention for displaying performance data on a user interface along with topology information of a monitored data storage network.

To further illustrate the use of movement, connection 420 is shown as representing zero utilization so it is shown as a solid line with no movement. Connection 421 in contrast shows data flowing to system 416 at a utilization rate of 60 to 80 percent. Connection 434 is also shown as solid with no utilization while connection 435 shows flow at a utilization rate of 60 to 80 percent (as will be understood, the motion and use of dashed lines made of line segments having varying lengths also allow a user to readily identify which connection is being shown when the connections overlap as they do in this case with system 416 being connected to Switch #222). Connection 438 is shown with data flowing to switch 432 at a utilization rate of 40 to 60 percent while data is flowing away from switch 432 in connection 439 at a utilization rate of 40 to 60 percent.

Nodes, such as computer system 414 (e.g., a server) and computer systems 460 and 462 (e.g., storage devices), are connected to the network and communicate between one another via switches 432 and 468. The switches in the network may include memory for storing port selections rules, routing policies and algorithms, buffer credit schemes, and traffic statistics. The storage management system 110 is connected to the network and can utilize the information gathered from the switches to track the flow of information in the network, as well as determine where potential network events are being generated on the network. An administrative database 132 (DB) is connected to the management station no that stores one or more of algorithms, buffer credit schemes, and traffic statistics, which are utilized to determine which portion of the network an event is occurring in. As understood by those having skill in the art, network management software accumulates the particular characteristics of a network by either: (1) polling switches via application programming interface (API), command line interface (CLI) or simple network management protocol (SNMP); or (2) receiving warnings from switches on the network via API or SNMP. The network management software then displays the particular characteristics being tracked in a window, such as a widget, for the network administrator.

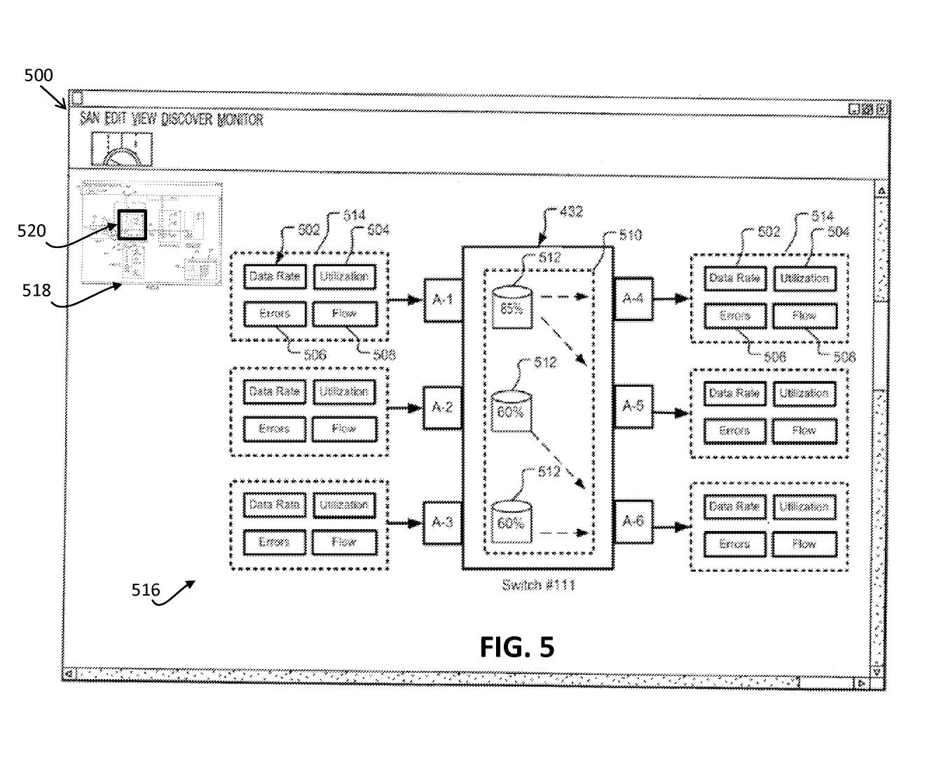

In an embodiment of the present invention, when the rule or policy service 122 has been triggered by crossing a preconfigured threshold, the storage management system may automatically alternate from the high level view illustrated in FIG. 4 to a detailed view of the ports of the switches or other devices that the rule or policy 122 indicates may be responsible for the network event. This may allow the administrator to quickly and efficiently analyze the source of a network and remediate the problem before the event significantly affects the network. For example, in reference to FIG. 4, a rule or policy service relating to region 466 may be triggered because the utilization level of the ports on switch 468 are well below their normal peak performance utilization levels. Rather than waiting until the administrator receives a support call from the users on the network affected by the potential congestion, the storage management system 110 may proactively and automatically measure additional detailed performance parameters in real-time using the performance monitoring mechanism 120. This may be accomplished, for example, by alerting the administrator that a potential network event may be occurring, and having the user input into the system a desire to alternate from the high level view to the detailed view. As illustrated in FIG. 5, the administrator's input may cause the storage management system 110 to generate a graphical representation of that switch, as well additional, detailed performance parameters relating to the switch and its ports. While the administrator entering an input is one means of zooming-in on a particular network device, it would be understood by those having ordinary skill in the art that the desired “zoom-in” device or region can be selected using a number of other input methods known in the field. For example, an administrator may select the desired network device or devices by clicking and dragging a frame around a portion of the network to be analyzed. This will cause the “zoom-in” feature to display granular information for multiple inter-connected devices. This may be especially helpful if multiple devices have triggered the rule or service policy, in which case any or all of those devices may be the source of a network event. An administrator may also manually type the name or address of the network device(s) desired to be zoomed-in on in a console. Moreover, the storage management system 110 may automatically alternate from the high level view to the detailed view upon a rule or policy being triggered without any intervention or input from an administrator. In this way, an administrator would not be required to take any action in order to view the granular information relating to a particular network event. Further, instead of alternating to the detailed view, a new window with the detailed view could be displayed.

In reference to FIG. 5, a new display 500 includes a detailed (i.e., zoomed-in) network topology 516 of the selected switch 432 from the high level topology 410. The detailed network topology 516 comprises a graphical representation of switch 432. The switch has a plurality of ports A-1 to A-6 (with only three ingress/egress ports being shown for simplicity, but the invention is useful for monitoring any number of ports on a network device), each of which is connected to the port of another device on the network (e.g., switch 468). Using this zoomed-in view, the administration may be able to view, among other performance parameters (i.e., granular information) 514: (1) the granular flow of data between the switch ports 510, (2) the data rate on each ingress and egress port 502, (3) the errors being generated by each ingress and egress port 506, (4) the data utilization of each port 504, and (5) the granular flow of data being received and transmitted by each port 508. Performance parameters such as these may be collected using the performance monitoring mechanism 120 illustrated in FIG. 1.

With regard to the granular flow data of the switch, the administrator can view the receive buffer 512 for each port, as well as the flow path the data traverses from the ingress to the egress ports. When an egress port is fed packets from one or more ingress ports faster than the egress port is able to transmit them, the receive buffer for the ingress port fills up with packets. When one or more of the receive buffers feeding the egress port are full with more packets waiting to arrive, the egress port of the switch becomes a bottleneck. This occurs, among other possible reasons, because the egress port is not getting enough credits back to transmit more packets or because the egress port is not fast enough to transmit at the rate it is being fed packets from one or more ingress ports. By being able to view the buffer utilization 512 of each port, an administrator can more quickly determine whether a true bottleneck exists on the network, or whether a bottleneck will soon exist (i.e., when a buffer is close to being full). Moreover, an administrator may be able to determine visually, using a simple flow path graphical representation, how the bottleneck on one port is spreading to other ports on the network. This may allow an administrator to take corrective action sooner than otherwise would be possible.

With regard to the data rate 502 on each ingress and egress port, the administrator can view, among other things, the overall data rate of each port, including the transmit and receive rates. This may prove especially helpful in oversubscription situations. Oversubscription generally occurs when end-user devices are utilizing more bandwidth than allowed for by the ports. Generally speaking, each port of a switch will be capable of transmitting at an equal bandwidth. However, because it is rare that every port on a switch will be fully utilized at any given time, administrators tend to intentionally “oversubscribe” the lines to the end-user devices. In other words, more end-user devices are assigned to each port to ensure that the bandwidth capability of the switch is substantially realized. When the end-user devices are experiencing abnormally high utilization levels, the switch ports are unable to meet the demand because they have been intentionally oversubscribed (i.e., more devices have been assigned to the port than the port can handle). This can cause the overall performance of the network to be decline and negatively affect the end-user's experience. For example, assume that switch 432 is a 12 gigabit per second (Gbgps) switch, where each of ports A1-A6 are 4 Gbps ports. Because it may be highly unlikely that all connected end-user devices will utilize 4 Gbps of bandwidth at any one time, additional end-user devices are connected to the switch to ensure that the frill capability of the switch is being substantially realized. When the total combined data requirements of the hosts exceed the switch 432 capabilities, network performance suffers. Consequently, an administrator may then need to allocate additional bandwidth to the hosts via other switches to alleviate the issue. The disclosed invention may aid an administrator in identifying over subscription situations before the end-users begin to experience network deterioration. Moreover, it may aid an administrator identify a bottleneck situation. For example, if the data rate of port A-4 is 2 Gbps (i.e., 50% of its capabilities) and during peak hours port A-4 typically has data rates around 3.5 Gbps (i.e., 87.5%), the administrator may be alerted that a network event has developed.

With regard to the utilization 504 of the switch 432, the administrator can view the data utilization of each port on the switch. Similar to the data rate 502 of the switch, knowing the data utilization of each port on the switch allows an administrator to determine the extent to which the ports on the switch are being used, which may indicate that the switch is oversubscribed, or that it is the source of bottlenecking because, for example, it is unable to send packets as fast as it is receiving them.

With regard to the errors 506, the disclosed invention allows an administrator to view the types of errors that are being generated by the switch. For example, a CRC error is an error generated when an accidental change in raw data has occurred as it traverses a network. This is accomplished by including a short “check value” as part of the data being sent. While CRC errors are not uncommon, a high number of CRC errors indicates a potential hardware or software failure on the part of the device sending or receiving the data transmission. Likewise, “invalid transmit word” (ITW) errors are utilized to verify data integrity as it is sent across a network. By allowing an administrator to zoom-in on a particular region of a network, the administrator can review the number of CRC/ITW errors being generated by a particular switch and take appropriate remedial action. While CRC and ITW errors have only been referenced as examples here, a person of ordinary skill in the art would recognize that the present invention may be utilized to monitor other types of errors, such as link timeout, credit loss, link failure/fault, and abort sequence errors.

With regard to the flow 508, the disclosed invention may allow an administrator to view the port from which a data transmission is received, as well as the port to which a data transmission is addressed. More specifically, the flow 508 on ports A-1 to A-3 allow an administrator to determine exactly where a data packet is being received from, while the flow 508 on ports A-4 to A-6 may allow an administrator to determine exactly where data packets leaving the egress ports are being sent to. This information may allow an administrator to determine which network devices are likely being affected by the device in the detailed network topology 516, or which device is adversely affecting the device in the detailed network topology 516. It will be appreciated that by utilizing the disclosed embodiment, an administrator may view a graphical representation of at least one utilized port of a network device and at least one performance parameter corresponding to the utilized port.

While the detailed performance parameters in the present embodiment are illustrated as part of the detailed network topology 516 in FIG. 5, it would be understood by those having ordinary skill in the art that the detailed performance parameters 514 could be displayed in a separate window or in another way in which the detailed performance parameters 514 are not actually illustrated as part of the topology 516. For example, the detailed network parameters may be displayed in a box or additional window that is not part of the detailed topology 516.

In addition to the detailed performance parameters discussed above, the detailed view may also include a mini-map 518 which includes the overall network topology. The region of the network that the detailed view is “zoomed-in” on, is indicated by a black square 520. However, as would be understood by those having ordinary skill in the art, any method or means of indicating the “zoomed-in” region is possible, such as by highlighting or circling the region.

While the disclosed invention allows an administrator to “zoom-in” on particular network device and its performance parameters (e.g., data rate, utilization, switch data flow, etc.), it would be understood by those having ordinary skill in the art that more data parameters known in the art may be configured to display when a user selects a particular network device or devices to zoom-in on. Moreover, while a certain arrangement of the performance parameters relative to the individual ports of the switch are shown, it would be understood by those of ordinary skill in the art that any arrangement sufficient to illustrate the performance parameters in such a way that the administrator can understand the granular flow of information through the individual port(s) of a device would be acceptable.

It will also be as recognized by those having ordinary skill in the art that by viewing the granular information of the switch ports, an administrator may be able to determine the source of a networking event (e.g., bottlenecking) more quickly. Utilizing the granular information obtained using the detailed network topology view, the administrator may be able to determine the particular source of bottlenecking. The ability of an administrator to view the granular flow of information in a network that is either the cause or victim of bottlenecking or another network event is critical to efficiently and expediently resolving the network event. Referring back to FIG. 4, an administrator may begin to detect the potential bottlenecking before it has substantially affected the network based on the rules or service policies put in place by the administrator prior to the network event occurring.

Additionally, while the disclosed embodiment only shows the “zoom-in” feature being utilized on a single network switch, those having ordinary skill in the art would understand that this feature can be utilized on any network connected device, such as a host computer or storage device. For example, the rules or policies may be triggered by multiple network devices, which then allow the administrator to view the detailed performance parameters (including granular flow) of the interconnected devices. The following embodiment illustrates this example.

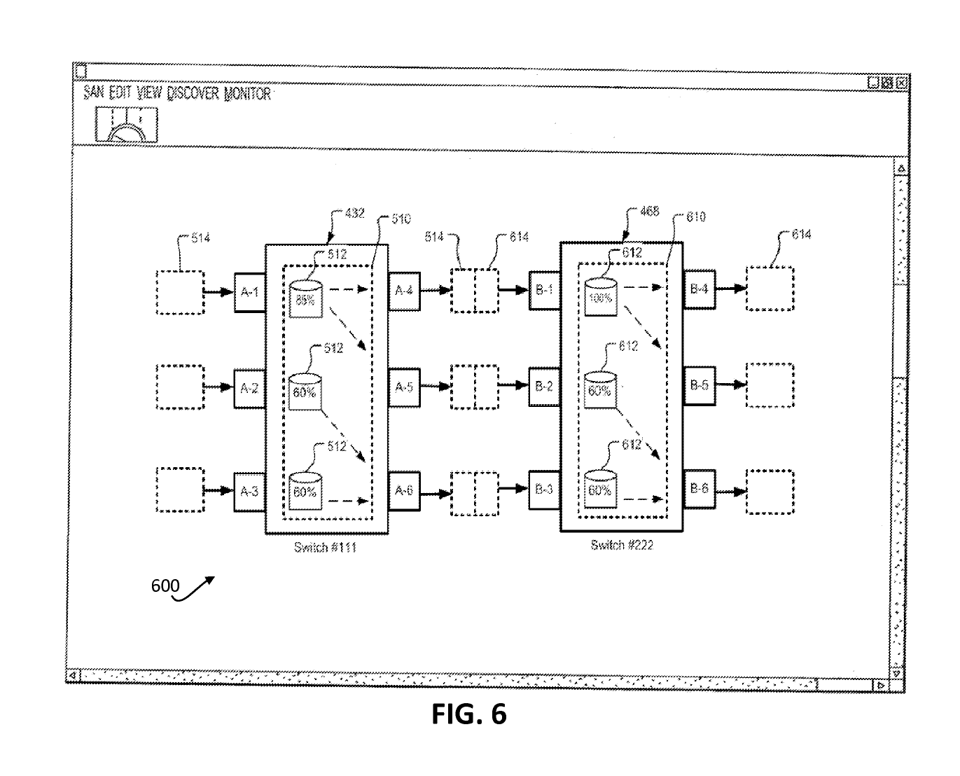

In reference to FIG. 6, an administrator may select switches 432 and 468 from FIG. 4, which will then display performance parameters 514, 510 and 614, 610 for each switch 432 and 468 respectively. In this embodiment, an administrator may immediately notice that the flow information 610 of switch 468 indicates that the buffer 612 relating to port B-1 is full and that the buffer 512 relating to port A-1 of switch 432 is nearly full at 85%. Using these data points, the administrator may be able to determine that switch 468 is the source of a bottleneck that is ultimately affecting other devices upstream of switch 468. Consequently, using the disclosed invention an administrator can view the data rate, flow, error rate, etc. of any network connected device or devices to determine which device is the source of, or affected by, a network event. This allows an administrator to take remedial action before the network event worsens. While not illustrated in FIG. 6, FIG. 6 may include a mini-map indicating the region of the network the “zoomed-in” feature is focused on.

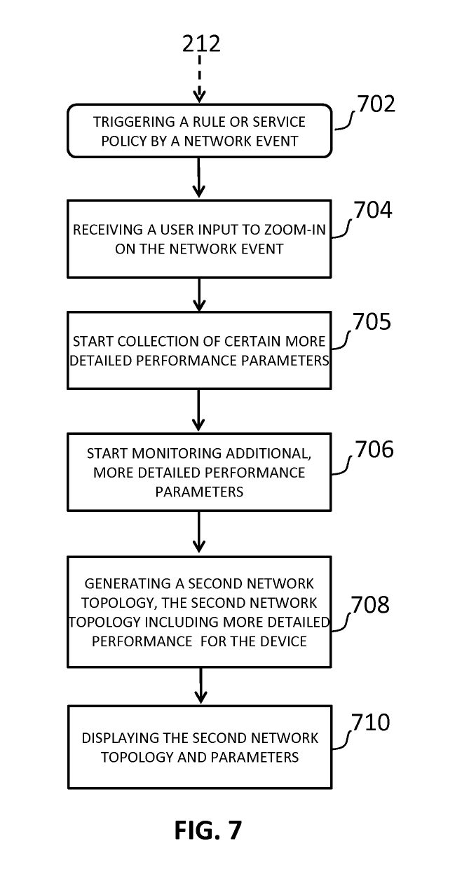

FIG. 7 is a flow chart illustrating steps in addition to those illustrated in the flow chart from FIG. 2. More specifically, after the step of generating a performance monitoring display 212, a rule or service policy is triggered by a potential network event 702. This trigger causes the network management software 110 to query whether the user elects to “zoom-in” on the affected portion of the network. Alternatively, the network management software 110 may skip step 704 and automatically initiate collection of selected more detailed performance parameters in step 705. While many detailed performance parameters may be monitored by the switch that are not normally monitored until a trigger occurs, in other cases even more detailed parameters can be obtained as desired. For example, in certain embodiments flows are not monitored in normal operation but flow monitoring can be initiated based on the trigger to obtain this very helpful information. After initiating the additional data collection in step 705, if desired, the network management software 110 may begin monitoring additional performance parameters or metrics at step 706. The network management system 110 then generates a second network topology 600 that includes at least one detailed performance parameter (e.g., data rate 502) relating to the selected switch 432 (step 708). The network management system then displays the second network topology relating to the switch 432 (including its detailed parameters) in the GUI 156 of the storage management system, as shown by step 710 and illustrated in FIG. 6. These more detailed parameters may be measured constantly and continuously in real-time, potentially allowing the administrator to more quickly determine the source of the potential network event.

It will further be realized that the present invention can be implemented together with any rule or service policy that may help identify the potential source of a network event. For example, service policies or rules may be implemented that alert the network administrator when a certain number of CRC errors are received from a particular network device, or when a certain utilization threshold has been met by a network device. These policies or rules may help an administrator identify the early onset of a network event, thereby allowing the administrator to probe using the detailed network topology feature.

It will further be realized that the presently disclosed invention may be utilized with a high level topology view in which no performance parameters are displayed, even though there are some performance parameters being sampled by the network management software 110.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, while communication networks using the Ethernet and FC protocols, with switches, routers and the like, have been used as the example in the Figures, the present invention can be applied to any type of data communication network.

1. A computer-based method comprising:
generating a first graphical topology representation of a network based upon stored network topology information;
monitoring at least one performance parameter(s) of the network;
triggering a rule or service policy based on the least one performance parameter(s);
monitoring at least one additional performance parameter(s) of at least one network device(s) on the network in response to the trigger; and
generating a second representation of the network, wherein the second representation includes: (1) a second graphical topology representation including the at least one network device(s); and (2) the display of the at least one additional performance parameter(s).

2. The method of claim 1, wherein the generating of the second graphical representation is triggered by a user input.

3. The method of claim 1, wherein the generating of the second graphical representation is performed automatically after the rule or service policy has been triggered.

4. The method of claim 1, wherein the additional performance parameter(s) is measured continuously and in real-time.

5. The method of claim 1, wherein the second graphical representation includes a mini-map and an indicator of the location of the at least one network device(s) on the network.

6. The method of claim 1, wherein the first graphical representation includes the at least one performance parameter.

7. The method of claim 1, further comprising:
initiating collection by the at least one network device of the at least one additional performance parameter(s).

8. A non-transitory computer readable storage medium or media having computer-executable instructions stored therein for an application which performs the following method, the method comprising:
generating a first graphical topology representation of a network based upon stored network topology information;
monitoring at least one performance parameter(s) of the network;
triggering a rule or service policy based on the least one performance parameter(s);
monitoring at least one additional performance parameter(s) of at least one network device(s) on the network in response to the trigger; and
generating a second representation of the network, wherein the second representation includes: (1) a second graphical topology representation including the at least one network device(s); and (2) the display of the at least one additional performance parameter(s).

9. The computer readable storage medium or media of claim 8, wherein the generating of the second graphical representation is triggered by a user input.

10. The computer readable storage medium or media of claim 8, wherein the generating of the second graphical representation is performed automatically after the rule or service policy has been triggered.

11. The computer readable storage medium or media of claim 8, wherein the additional performance parameter(s) is measured continuously and in real-time.

12. The computer readable storage medium or media of claim 8, wherein the second graphical representation includes a mini-map and an indicator of the location of the at least one network device(s) on the network.

13. The computer readable storage medium or media of claim 8, wherein the first graphical representation includes the at least one performance parameter.

14. The computer readable storage medium or media of claim 8, wherein the method further comprises:
initiating collection by the at least one network device of the at least one additional performance parameter(s).

15. A computer system comprising:
a processor;
a display device coupled to said processor; and
storage coupled to said processor and storing computer-executable instructions for an application which cause said processor to perform the following steps:
generating a first graphical topology representation of a network based upon the stored network topology information;
monitoring at least one performance parameter(s) of the network;
triggering a rule or service policy based on the least one performance parameter(s);
monitoring at least one additional performance parameter(s) of at least one network device(s) on the network in response to the trigger; and
generating a second representation of the network, wherein the second representation includes: (1) a second graphical topology representation including the at least one network device(s); and (2) the display of the at least one additional performance parameter(s).

16. The system of claim 15, wherein the generating of the second graphical representation is triggered by a user input.

17. The system of claim 15, wherein the generating of the second graphical representation is performed automatically after the rule or service policy has been triggered.

18. The system of claim 15, wherein the additional performance parameter(s) is measured continuously and in real-time.

19. The system of claim 15, wherein the second graphical representation includes a mini-map and an indicator of the location of the at least one network device(s) on the network.

20. The system of claim 15, wherein the first graphical representation includes the at least one performance parameter.

21. The system of claim 15, wherein the computer-executable instructions for the application cause the processor to perform the following additional step:
initiating collection by the at least one network device of the at least one additional performance parameter(s).
